(19) United States
(12) Patent Application Publication
(10) Pub. No.: US 2013/0198782 A1
(43) Pub. Date: Aug. 1, 2013

(54) FREE SPACE SCROLLER FOR ELECTRONIC PROGRAMMING GUIDE

(71) Applicants: Kevin Arruda, Portsmouth, NH (US); John Nguyen, San Jose, CA (US)

(72) Inventors: Kevin Arruda, Portsmouth, NH (US); John Nguyen, San Jose, CA (US)

(73) Assignee: NIVEUS MEDIA, INC., Fremont, CA (US)

(21) Appl. No.: 13/565,348

(22) Filed: Aug. 2, 2012

Related U.S. Application Data
(60) Provisional application No. 61/514,828, filed on Aug. 3, 2011.

(51) Int. Cl. H04N 21/482

(52) U.S. Cl. CPC H04N 21/4821
USPC 725/52

(57) ABSTRACT

A computing device displays an electronic programming guide. The computing device receives a multi-axis scrolling command. In response to the command, the device scrolls the EPG along both a time axis and a channel axis based on the multi-axis scrolling command.

### CROSS-REFERENCE TO RELATED APPLICATIONS

This application claims the benefit of U.S. Provisional Patent Application No. 61/514,828, filed Aug. 3, 2011, which is hereby incorporated by reference herein.

### FIELD OF THE INVENTION

The present invention relates to electronic programming guides, and more particularly to navigation of electronic programming guides.

### BACKGROUND OF THE INVENTION

Cable service providers such as Comcast and Dish Networks provide linear electronic programming guides (EPGs) to users on a dedicated channel. Service providers or affiliates may also distribute programming data to populate an EPG. Set top boxes and other computers then generate an interactive EPG based on the programming data. Conventional EPGs include a graphical user interface (GUI) that consists of a table that lists channels along a vertical axis and time slots along a horizontal axis. Therefore, each row of the table is for a different channel, and each column of the table is for a different time slot. To navigate a conventional EPG, a user enters a series of single-axis scrolling commands. Each single axis scrolling command either scrolls along the horizontal axis or along the vertical axis. For example, for a user to scroll from a 1:00 showing at channel 1 to a 10:00 showing at channel 8, the user would enter the channel down command 7 times, and would enter the advance time command some number of times that depends on the number of programs between the 1:00 time and the 10:00 time. This can be an inefficient way for a user to navigate an EPG.

### BRIEF DESCRIPTION OF THE DRAWINGS

The present invention is illustrated by way of example and not limitation in the figures of the accompanying drawings, in which like references indicate similar elements and in which:

FIG. 1 illustrates an electronic programming guide, in accordance with one embodiment of the present invention;

FIG. 2 illustrates a flow diagram for a method of performing multi-axis scrolling within an electronic programming guide; and

FIG. 3 illustrates a diagrammatic representation of a machine in the exemplary form of a computer system.

### DETAILED DESCRIPTION

Described herein are methods and apparatuses for performing multi-axis scrolling within an electronic programming guide (EPG). In one embodiment, a computing device displays an electronic programming guide (EPG). The EPG may include a vertical channel axis and a horizontal time axis. The computing device receives a multi-axis scrolling command. In response to the command, the device scrolls the EPG along both the time axis and the channel axis based on the multi-axis scrolling command. This may cause a user to reach a desired channel and time more quickly than can be achieved using the single axis scrolling commands that are available in traditional EPGs.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed description which follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “searching”, “calculating”, “scrolling”, “displaying” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

A machine-readable medium may include any mechanism for storing or transmitting information in a form readable by a machine (e.g., a computer). For example, a machine-readable medium includes a machine readable storage medium such as a read only memory (“ROM”), random access memory (“RAM”), magnetic disk storage media, optical storage media, flash memory device, etc.

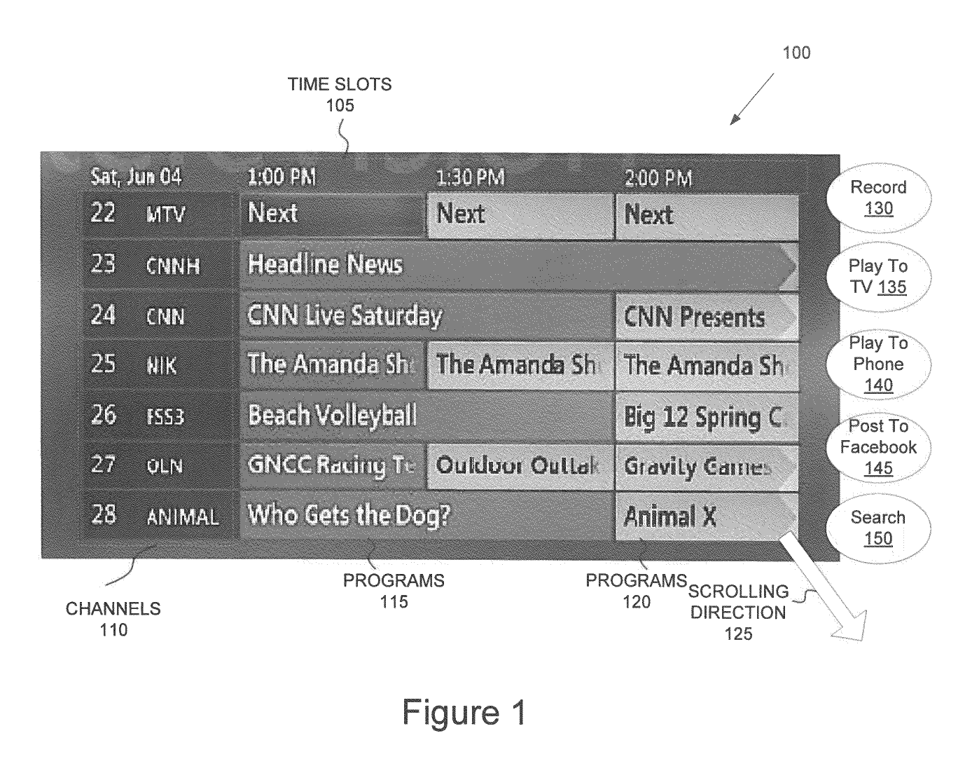

FIG. 1 illustrates an electronic programming guide (EPG) 100, in accordance with one embodiment of the present invention. The EPG 100 is an interactive EPG that allows users to navigate program scheduling and initiate actions associated with selected programs. The EPG 100 may be a two dimensional grid that includes columns and rows. Each column may represent a distinct time slot 105, and each row may represent a distinct channel 110. Each cell of the grid may be the intersection of a specific channel 110 and one or more time slots 105. Each cell may include a particular program that will be aired on a specific channel at a specified time. For example, the program “who gets the dog” will show on channel 28 at 1:00 PM and 1:30 PM.

The time slots 105 may be associated with a horizontal time axis, and the channels may be associated with a vertical channel axis. As shown, the Program “Next” airing at 1:00 on channel 22 is selected. In a conventional system, for a user to navigate to “Animal X”, which airs at 2:00 on channel 28, the user would first need to press a channel down button multiple times to navigate to channel 28. The user would then need to press a fast forward button to navigate to the 2:00 time slot. Alternatively, the user could press the fast forward button and then the channel down buttons. In either case, in traditional systems, a user must provide a series of vertical or horizontal scrolling commands to navigate the EPG. Each scrolling command in the traditional system causes the program selection to move vertically or horizontally a fixed number of cells (usually a single cell).

In one embodiment, the EPG 100 can be scrolled horizontally, vertically and/or diagonally based on an open ended input. The input may be based on a user interacting with a touch screen, a scroll ball, a mouse, or other multi-axis input device. For example, a user may input a multi-axis scrolling command to cause the EPG 100 to scroll in scrolling direction 125. This may be a continuous command or a single input command, based on a user's action. For example, if a user keeps his finger on a touch pad and keeps moving his finger, then the EPG may continue to scroll in the direction that the finger is moving. This may cause the selected cell to switch from channel 22 at 1:00 to channel 23 at 1:30 and then channel 24 at 2:00, and so on. As the user continues to input a scrolling command, the EPG's display may update to display new cells. For example, channels 29 and 30 and time slots 2:30 and 3:00 may be displayed.

In one embodiment, the EPG 100 is a set of tiles, where each tile represents a program, and is disposed at a time slot and channel intersection. Each tile may have a length that is proportional to a run time of an associated channel, and may have a preset height. Each tile may be an object that has multiple properties or attributes. Object attributes may include a start time, an end time, a channel, a content source (e.g., Comcast, Dish Network, Hulu, etc.), a content type, an image, and/or other properties. A user may select a tile, and may then perform one or more actions, such as scheduling a recording, selecting a device to stream program content to, posting program content to a social network, and so forth. In one embodiment, the user initiates an action by dragging the selected tile to an icon or image that represents a particular action or function. For example, the EPG 100 may include a record icon 130, a play to TV icon 135, a play to phone icon 140, a post to facebook icon 145, a search icon 150, and so on. Dragging a tile to the record 130 icon may schedule a recording for the program associated with the tile. Dragging to the play to TV 135 or play to phone 140 icons may cause a program to be streamed to a particular TV or phone, respectively. Dragging a tile to the post to facebook icon 145 may cause material to be posted to a user's facebook account. Dragging a tile to the search icon 150 may cause a search for similar program content to be initiated. The search results may show other times for the program, may show additional information about the program, or may show similar programs.

In an example, by selecting the 2:00, channel 24 “CNN Presents” tile to record 130, the user may easily schedule a recording. A computing device such as a digital video recorder (DVR) may then automatically record the CNN presents program at 2:00. Accordingly, in one embodiment, the EPG is more than simply a text in a table. Rather, each cell or tile may be a distinct object that can be used to initiate one or more actions.

In one embodiment, two types of multi-axis scrolling commands may be performed within the EPG 100. A first scrolling command type changes the channels and/or time slots that are displayed without changing a tile/cell selection. Therefore, the EPG may be navigated in a similar manner to a zoomed in canvas or image. The user may then tap or click on a particular cell/tile to select that cell/tile. A second scrolling command type changes a tile/cell selection, and does not necessarily change the displayed channels/time slots. If the user attempts to scroll in a direction for which no channel or time slot is currently displayed, then the display of the EPG 100 may be updated to show additional channels and/or time slots.

In one embodiment, the user may additionally issue commands to zoom in or to zoom out of the EPG.

In one embodiment, a selected tile/cell is indicated by expanding the dimensions of the selected tile/cell, by changing a color of the selected cell, by changing a font of the selected tile/cell, and/or by other techniques. In one embodiment, a selected tile is graphically shown to raise above the other cells/tiles of the EPG 100. In one embodiment, additional information about the program associated with the selected tile/cell is shown. The additional information may be retrieved from one or more external sources.

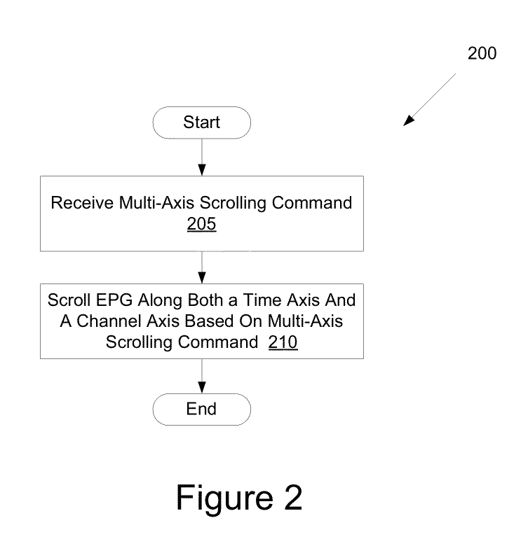

FIG. 2 illustrates a flow diagram for a method 200 of performing multi-axis scrolling within an electronic programming guide. The method may be performed by processing logic that may comprise hardware (e.g., circuitry, dedicated logic, programmable logic, microcode, etc.), software (such as instructions run on a processing device), or a combination thereof. In one embodiment, method 200 is performed by a computing device that includes an electronic programming guide.

Referring to FIG. 2, at block 205, processing logic receives a multi-axis scrolling command. The command may be received from a multi-axis input device. In one embodiment, the command is received from a remote control that includes a touch pad, a scroll ball, or an accelerometer and a logic that transforms motions into multi-axis commands.

At block 210, processing logic scrolls the EPG along both a time axis and a channel axis based on the multi-axis scrolling command. The EPG may scroll along the time axis and the channel axis simultaneously. In one embodiment, the ratio of scrolling along the time axis and scrolling along the channel axis is dependant upon the multi-axis scrolling command. For example, if the user swiped downward on a touch pad at approximately a 45 degree angle, then the time axis scrolling and channel axis scrolling may be equivalent. For example, the EPG may scroll down one channel and across one time slot on a 1 to 1 basis. If on the other hand the user swiped downward on the touch pad at approximately a 60 degree angle, then the EPG may scroll down two channels for every 1 time slot that it scrolls across (e.g., a 2 to 1 scrolling ratio). Other scrolling ratios may be applied based on different angles of diagonal multi-axis input.

Scrolling the EPG may include changing a program selection and/or changing which time slots and/or channels are displayed in the EPG.

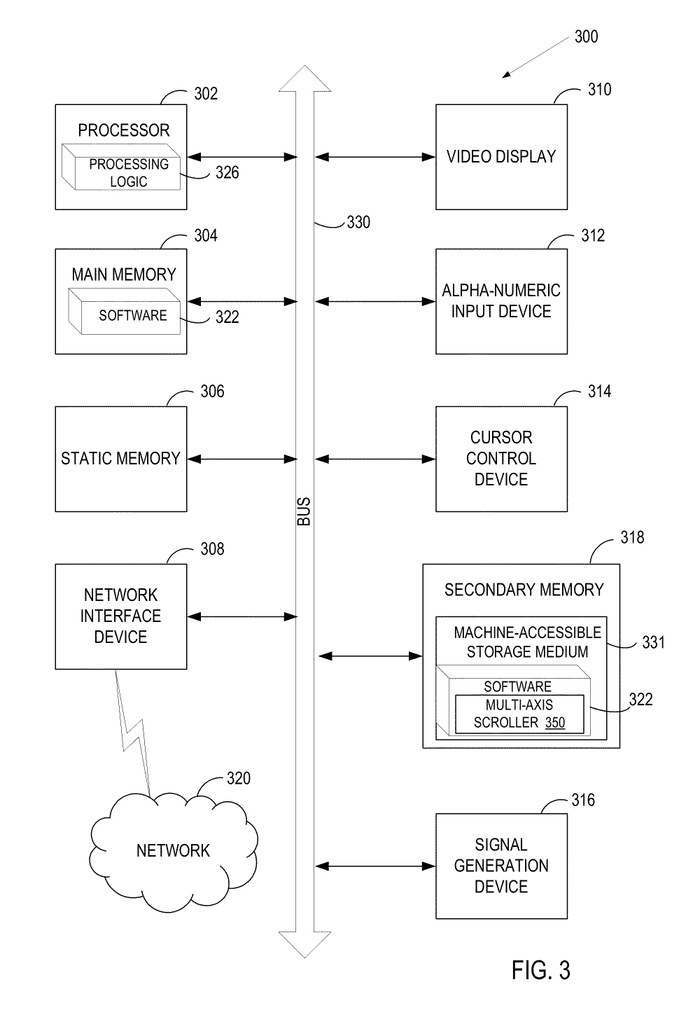

FIG. 3 illustrates a diagrammatic representation of a machine in the exemplary form of a computer system 300 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processing device (processor) 302, a main memory 304 (e.g., read-only memory (ROM), flash memory, dynamic random access memory (DRAM) such as synchronous DRAM (SDRAM) or Rambus™ DRAM (RDRAM), etc.), a static memory 306 (e.g., flash memory, static random access memory (SRAM), etc.), and a secondary memory (e.g., a data storage device) 318, which communicate with each other via a bus 330.

Processor 302 represents one or more general-purpose processing devices such as a microprocessor, central processing unit, or the like. More particularly, the processor 302 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 302 may also be one or more special-purpose processing devices such as an application specific integrated circuit (ASIC), a field programmable gate array (FPGA), a digital signal processor (DSP), network processor, or the like. The processor 302 is configured to execute the processing logic 326 for performing the operations and steps discussed herein.

The computer system 300 may further include a network interface device 308. The computer system 300 also may include a video display unit 310 (e.g., a liquid crystal display (LCD) or a cathode ray tube (CRT)), an alphanumeric input device 312 (e.g., a keyboard), a cursor control device 314 (e.g., a mouse, touchpad or touch display), and a signal generation device 316 (e.g., a speaker).

The data storage device 318 may include a machine-accessible storage medium 331 on which is stored one or more sets of instructions (e.g., software 322) embodying any one or more of the methodologies or functions described herein. The software 322 may also reside, completely or at least partially, within the main memory 304 and/or within the processor 302 during execution thereof by the computer system 300, the main memory 304 and the processor 302 also constituting machine-accessible storage media. The software 322 may further be transmitted or received over a network 320 via the network interface device 308. In one embodiment, the software 322 includes instructions for a multi-axis scroller 350. The multi-axis scroller 350 may perform one or more of the scrolling functions described above.

While the machine-accessible storage medium 331 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instructions for execution by the machine and that cause the machine to perform any one or more of the methodologies of the present invention. The term “machine-accessible storage medium” shall accordingly be taken to include, but not be limited to, solid-state memories, optical and magnetic media, and carrier wave signals.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A computerized method, comprising:
receiving a multi-axis scrolling command by a device displaying an electronic programming guide; and
scrolling the EPG along a time axis and along a channel axis based on the multi-axis scrolling command.
